(19) United States
(12) Patent Application Publication
(10) Pub. No.: US 2021/0284462 A1
(43) Pub. Date: Sep. 16, 2021

(54) TRACK SYSTEM FOR CREATING FINISHED PRODUCTS WITH MULTI-DIMENSIONAL WARNING SYSTEM

(71) Applicant: The Procter & Gamble Company, Cincinnati, OH (US)

(72) Inventor: Daniel Richard Royce, Blue Ash, OH (US)

(21) Appl. No.: 17/191,795

(22) Filed: Mar. 4, 2021

Related U.S. Application Data
(60) Provisional application No. 62/987,691, filed on Mar. 10, 2020.

(51) Int. Cl. B65G 43/02; B65G 54/02

(52) U.S. Cl. CPC B65G 43/02; G06Q 10/0639; B65G 54/02

(57) ABSTRACT

A track system includes a transport portion along which a plurality of vehicles can be propelled to unit operation stations for performing a transformation on a container or the contents therein on a vehicle. The track system utilizes a multi-dimensional warning system.

### TECHNICAL FIELD

The systems and methods described below generally relate to a track system and methods for transporting at least one container to one or more unit operation stations.

### BACKGROUND

High speed container filling systems are well known and used in many different industries. In many of the systems, fluids are supplied to containers to be filled through a series of pumps, pressurized tanks and flow meters, fluid filling nozzles, and/or valves to help ensure the correct amount of fluid is dispensed into the containers. These high speed container systems are typically systems that are configured to only fill one type of container with one type of fluid. When a different container type and/or different fluid is desired from the system, the configuration of the system must be changed (e.g., different nozzles, different carrier systems, etc.) which can be time consuming, costly, and can result in increased downtimes. To provide consumers with a diverse product line, a manufacturer must employ many different high speed container systems which can be expensive and space intensive.

These high speed container filling systems are also typically incapable of providing different containers and arrangements of containers in a package without manual handling of the containers and/or packaging which can be time consuming, expensive, and frequently inaccurate.

Various patent publications disclose article handling systems (though not necessarily container filling systems). These include: U.S. Pat. No. 6,011,508, Perreault, et al.; U.S. Pat. No. 6,101,952, Thornton, et al.; U.S. Pat. No. 6,499,701, Cho; U.S. Pat. No. 6,578,495, Yitts, et al.; U.S. Pat. No. 6,781,524, Clark, et al.; U.S. Pat. No. 6,917,136, Thornton, et al.; U.S. Pat. No. 6,983,701, Thornton, et al.; U.S. Pat. Nos. 7,011,728 B2, 7,264,426 B2, Buttrick, Jr.; Dewig, et al.; U.S. Pat. No. 7,448,327, Thornton, et al.; U.S. Pat. No. 7,458,454, Mendenhall; U.S. Pat. No. 8,591,779 B2, Senn, et al.; U.S. Pat. Nos. 9,032,880; 9,233,800 B2, Senn, et al.; U.S. Patent Application Publications US 2015/0079220 A1 (now U.S. Pat. No. 9,283,709 B2, Lindner, et al.) and US 2016/114988 A1; and, EP Patent 1 645 340 B1. The search for improved high speed container filling systems has continued.

Thus, it would be advantageous to provide a filling system and methods of filling containers with an improved traffic control system. It would also be advantageous to provide a filling system and a method of filling containers that are versatile and can fill different containers with different fluids simultaneously. It would also be advantageous to provide a filling system and a method of filling containers that allows for on-demand fulfillment of orders without requiring manual packing.

Some embodiments of such an advantageous filling system are known and depend on a track system to maneuver materials and products through a flexible filling system. Some examples are described by U.S. Pat. No. 10,558,201, Burkhard et al, US Publication Number 2018-0072445 A1 filed Sep. 8, 2017, Burkhard et al. or US Publication Number 2018-0076069 A1 filed Sep. 8, 2017, Burkhard et al. Such systems often include a plurality of unit operation stations linked in a flexible and adaptable manner by a track system. The flexibility of the systems enables them to often continue production even while one or more unit operation stations is not functioning albeit at reduced production rates. This robustness is beneficial so as to avoid a complete loss of production in the event of a single failure. However, this robustness does not prevent a partial loss in throughput, and so it can be difficult for operators to detect when production is not occurring at optimal rates. So, it would be advantageous to have a multi-dimensional alarm system capable of detecting abnormalities in such a track-based system, so as to cause corrective actions to be taken to restore optimal throughput with the least lost production possible.

### SUMMARY

The present invention proposes a multi-dimensional alarm system for use with production systems that comprise unit operation stations, one or more track systems, one or more vehicles traversing said one or more track systems, and one or more articles disposed on said one or more vehicles. The multi-dimensional alarm system monitors data observed from any one or a combination of the unit operation stations, the track(s), the vehicle(s), and the article(s) so as to detect situations causing undesirable production. Undesirable production may be production where the rate of products produced is less than a target rate, production where the yield is less than a target yield, or production incurring costs greater than a target cost.

Alarm systems that detect sub-optimal conditions for individual unit operation stations are common in the manufacturing industry. Such alarm systems are beneficial to call attention to problem conditions so as to expediently resolve the problem condition with minimal losses. However, such known alarm systems are limited in that they monitor only conditions inside of a particular machine. They are typically designed to monitor data provided by a fixed set of sensors or other feedback mechanisms, and although some have configurable alarm limits, generally only monitor specific conditions that were predicted by machine designers before the equipment was constructed and put into service.

A multi-dimensional alarm system is advantageous in that it can monitor data provided by one sub-system (i.e. unit operation stations or track or vehicles) in a track-based filling system, and use said data to infer that a problem condition exists in another sub-system. Such cross-sub-system alarm conditions may be pre-meditated and designed into the system before the system is constructed and put into service. However, such conditions may also be defined after the system has been put into service, as observations made while the system is in production result in defining previously un-documented relationships between data observed in one sub-system and problem conditions in another sub-system.

A multi-dimensional alarm system responds to detected anomalies in a variety of ways. The system may alert operators so as to trigger a manual intervention, or may trigger an automated response to mitigate or resolve the problem, or a combination thereof. With respect to the alert operators response type, the alert may take many forms, including but not limited to audible or visual indications on fixed user interfaces, alerts on mobile devices carried by or otherwise positioned near operators, remote signaling including automated phone calls, text messages, and the like, updates on web pages used to indicate problem conditions, etc. Even among these alert operators responses, there may be different forms or alerts, for example different audible sounds for different problems or problem types, or various visualizations for various problems or problem types, including varying displayed colors, shapes, sizes, text, and the like. In any of the alert operators responses, the alerts may be directed at all possible recipients of such alerts, or the alerts may be targets to specific sub-sets of personnel, for example the personnel most qualified to most quickly resolve the problem, or personnel who may need to take action in other systems to mitigate effects of a problem condition (adjust production schedules, shut down equipment that will be starved of materials or have an excess of materials, etc.).

A multi-dimensional alarm system is further advantageous in that it can monitor data from multiple sub-systems simultaneously. The multi-dimensional alarm system may consider information regarding the operational state of a unit operation station as well as information concerning positions and movements of vehicles along a track system. By combining this information, the system may differentiate between different problem states that may cause vehicles to fail to advance beyond the unit operation station. For example, if the unit operation station has detected a lack of materials available to it at the time the vehicles are observed failing to advance beyond the unit operation station, the multi-dimensional alarm system may alert a subset of operators responsible for providing materials, whereas the multi-dimensional alarm system may have alerted a different subset of operators responsible for maintaining vehicles if the same vehicle movement problem is observed without a corresponding problem reported by the unit operation station.

In another non-limiting example of the benefit of such cross-system monitoring, an exemplary problem condition in a unit operation station will now be discussed. In a filling system comprising bottle loading unit operation stations, filling unit operation stations, capping unit operation stations, bottle unloading unit operation stations, a track along with each of the aforementioned unit operation stations is disposed, vehicles which travel along said track in a controlled manner in accordance with routing and movement profiles as defined by one or more controllers, and bottles which may be disposed on said vehicles so as to facilitate the filling, capping, and unloading of said bottles, a potential problem condition may be a filling unit operation station software bug that results in the filling operation station failing to complete a filling operation, and failing to eject a vehicle carrying a bottle from said filling operation station in a timely manner. Such a system may be detected by conventional software integral to said filling operation station. However, such a detection would necessarily have to have been predicted by the designers of said filling operation station so as to have been built in to the software for the filling operation station. However, had said designers of said filling operation station predicted this software bug, reasonable designers would have instead eliminated the bug. Since, for the purpose of this discussion, the software bug existed, said designers of said filling operation station failed to predict its presence, and so no conventional alarm was built in to said filling operation station to detect said software bug. In this situation, a multi-dimensional alarm system configured to monitor the movements and positions of said vehicles on said track could have been configured to detect when one or more of said vehicles has not departed from the location of said filling unit operation station in a timely manner.

In this way, despite the multi-dimensional alarm system not necessarily having any direct interface into the controller of said filling unit operation station, and also despite the multi-dimensional alarm system not having awareness of what the specific problem condition inside of the filling unit operation station is, the multi-dimensional alarm system will still be able to swiftly alert operators to the presence of a problem with the filling unit operation station that could otherwise persist undetected for an extended period of time. In such a filling system, such a problem with a single one of potentially many filling unit operation stations may cause only a partial loss in throughput, but the partial loss in throughput continuing for said extended period of time may accumulate substantial lost production that would have been avoided with a multi-dimensional alarm system. Such a multi-dimensional alarm system is also able to use similar detections to detect such failure modes in any unit operation station, even when those unit operation stations perform substantially different operations and may use different equipment with different controller technologies.

### BRIEF DESCRIPTION OF THE DRAWINGS

It is believed that certain embodiments will be better understood from the following description taken in conjunction with the accompanying drawings in which:

FIG. 1 is a schematic view depicting a track system having a track and a control system, in accordance with one embodiment.

FIG. 1A is a schematic view of a track system having an alternative configuration.

FIG. 1B is a schematic view of a track system having another alternative configuration.

FIG. 1C is a schematic view of a track system having another alternative configuration.

FIG. 1D is a fragmented schematic view of a track system having another alternative configuration.

FIG. 2 is an exploded isometric view depicting a vehicle for the track system of FIG. 1 associated with a container.

FIG. 3 is a side view of the vehicle of FIG. 2.

FIG. 4 is an isometric view depicting a straight portion of the track of FIG. 1.

FIG. 5 is an isometric view depicting a curved portion of the track of FIG. 1.

FIG. 6 is an isometric view depicting a transition portion of the track of FIG. 1.

FIG. 7 is an isometric view depicting a filling/capping station of the track of FIG. 1.

FIG. 8 is an enlarged schematic view of a secondary transport portion, in accordance with another embodiment.

FIG. 9 is a schematic view of the control system of FIG. 1.

FIG. 10 is a representative screenshot of a portion of a track system.

FIGS. 11A-D show four representative alarm configurations.

### DETAILED DESCRIPTION

### Definitions

The term “capping”, as used herein, refers to applying any suitable type of closure to a container, and includes but is not limited to applying a cap to a container.

The term “constraints”, as used herein as in “constraints on arriving at one or more unit operation stations”, refers to limitations or restrictions on a vehicle arriving at one or more unit operation stations. Examples of constraints on arriving at one or more unit operation stations include: the infeed queue not being full; and requirements that one or more containers arrive before one or more other containers in order to form a specific package.

The term “container”, as used herein, refers to an article that is capable of holding a material, such as a fluent material, and includes, but is not limited to bottles, unit dose pods, pouches, sachets, boxes, packages, cans, and cartons. The containers can have a rigid, flexi-resilient, or flexible structure in whole or in part.

The term “container-loaded”, as used herein, means having one or more containers disposed thereon.

The term “container treatment operation”, as used herein, refers to one or more of the following unit operations: (a) a filling operation station for dispensing fluent material into a container; (b) a decorating operation; and (c) a capping operation. The term “container treatment operation” does not include the operations of loading and/or unloading containers onto the vehicles. When the term “container treatment operation” is said to be performed on a container-loaded vehicle, it is understood that the operation can be performed on the container and/or its contents, as appropriate.

The term “decoration”, as used herein, refers to a visual, tactile, or olfactory effect applied by means of material deposition that is applied directly, or transferred to an article or by transforming a property of an article, or combinations thereof. The article may include the container and/or the closure. Examples of a material deposition that is applied directly to an article include, but are not limited to applying a label to an article (labelling), and/or printing on an article. An example of transforming a property of an article without transferring a material to the surface of the article is imparting an image on the surface of an article by a laser. The term “decorating”, as used herein, refers to the act of applying a decoration.

The term “different finished products”, as used herein, means differing in container volume, container shape, container size, contained material volume or mass, contained ingredients, contained fluent product composition, container or closure appearance, closure type, container composition, closure composition, or other finished product attribute. The “appearance” of a container (and a closure) refers to its color, and any decoration thereon including any label or label contents thereon. When the finished products are described as differing from each other in one of more of the foregoing properties, it is meant to include those differences other than minor differences that are the result of variations within manufacturing tolerances.

The term “different fluent products”, as used herein, means differing in at least one property such as: state (e.g., liquid, solid, or non-headspace gas), differing amounts of one or more states of matter in the fluent products, differences in ingredients, differing amounts of one or more ingredients in the fluent products, observable properties (as perceived or measured by an observer such as color, scent, viscosity), particle size of any solid particles, and other properties. When the fluent products are described as differing from each other in one of more of the foregoing properties, it is meant to include those differences other than minor differences that are the result of variations within manufacturing tolerances. With respect to differences between two different fluent products based on their respective ingredient(s), it means when one of the two fluent products comprises an ingredient that is absent from the other fluent product. With respect to differing amounts of at least one same ingredient in two different fluent products, it means when the two different fluent products each contain the at least one same ingredient with a minimum or greater difference based on weight, as determined by one or both of the following methods. Both methods rely on knowledge of the proportion of said same ingredient in each different formula as a weight percent of the total fluent product weight of the total amount fluent product(s) contained with each fluent product's respective container associated with their respective finished product. Method 1 determines that two fluent products are different if the ratio of the weight percent of the same ingredient in the two fluent products is greater than or equal to about 1.1 (and, thus, greater than or equal to about 1.25) as determined by dividing the weight percent that is the greater of the two fluent products by the weight percent that is the lesser of the two fluent products. Method 2 applies to when the weight percent of the same ingredients are each present in each of the fluent materials is minimally equal to or greater than 2% (as expressed as a weight percent) and the difference of the weight percent of the same ingredient in the two fluent products is about equal or greater than 2%, or any integer % value up to and including 99%, as determined by subtracting the weight percent that is the greater of the two fluent products by the weight percent that is the lesser of the two fluent products. Different fluent products refer to the entirety of the weight sum of fluent product(s) contained within a finished product wherein the fluent product(s) may be contained within one or multiple fluent product-containing chambers. Non-headspace gas refers to pressurized gas of which examples include: propellant gas such as for aerosol products and pressurized gas for a sealed chamber to provide structural support or shape definition to a container.

The terms “disposed on” or “disposed thereon”, as used herein with reference to the containers on container-loaded vehicles, means any of the following: held by, affixed to, or otherwise coupled to in a removable manner. When the containers are described as being disposed on the vehicles, the container(s) can be in any suitable orientation with respect to the vehicles including, but not limited to: on top of the vehicles, underneath the vehicles, adjacent to one or more of the sides of the vehicles, or (if there are more than one container disposed on a vehicle) any combinations thereof.

The term “fast cycle”, with respect to stations, refers to inspection stations, such as weighing stations, scanners (e.g., for scanning bar codes, QR codes, RFID codes, etc.), vision systems, metal detectors, and other types of stations in which the task performed at such stations are carried out in a minimal amount of time relative to at least some other unit operation stations.

The term “finished product”, as used herein, comprises a container, the fluent material (or contents) therein, any decoration on the container, and the closure on the container.

The term “fluent product” (or “fluent material”), as used herein, refers to liquid products, gels, slurries, flowable pastes, pourable solid products (including, but not limited to granular materials, powders, beads, and pods), and/or gaseous products (including, but not limited to those used in aerosols).

The term “holding pattern”, as used herein, means that at least one (empty) vehicle or container-loaded vehicle travels past at least one point on a closed loop (of a main closed loop or sub-loop) twice while traveling in the same direction without an intervening trip in the opposite direction past said point. In addition, the term “holding pattern” means that the container-loaded vehicle also does not unload a container in between passing through the point twice. Thus, a typical operation of recirculating a vehicle to make a second product after using the vehicle to make a first product would not be considered moving the vehicle in a holding pattern. When it is said that a container is “empty”, the container will be considered to be empty even though it contains atmospheric air therein.

The term “infeed queue”, as used herein, refers to an area where vehicles wait for a unit operation station to become ready to receive the vehicles. The infeed queue can be expressed in terms of a length of track or a number of vehicles that can be queued in this area. Different unit operation stations may either have the same or different infeed queue lengths. Therefore, the queue lengths of some unit operation stations may be shorter or longer than the queue lengths at other unit operation stations. The infeed queue can (if using the number of vehicles) range from 0 (if no vehicles are able to wait in front of a given vehicle), up to hundreds of vehicles. In some cases, the queue length may be between about 2-10 vehicles.

The term “inspection”, as used herein, may include any of the following: scanning weighing, detecting the presence or orientation of a container, or other types of inspection. Inspections may be performed by weighing stations, scanners (e.g., for scanning bar codes, QR codes, RFID codes, etc.), vision systems, metal detectors, and other types of stations.

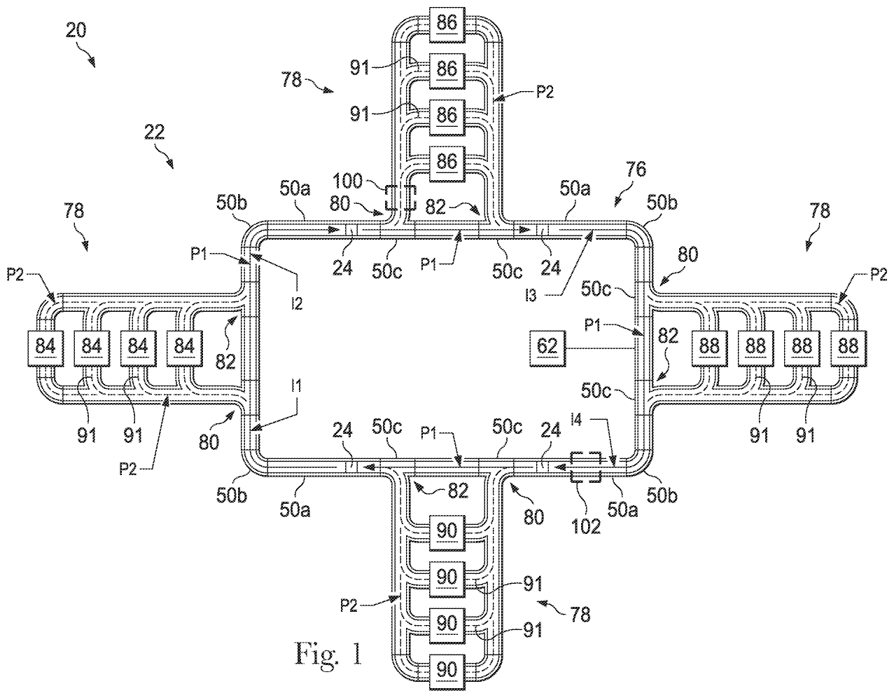

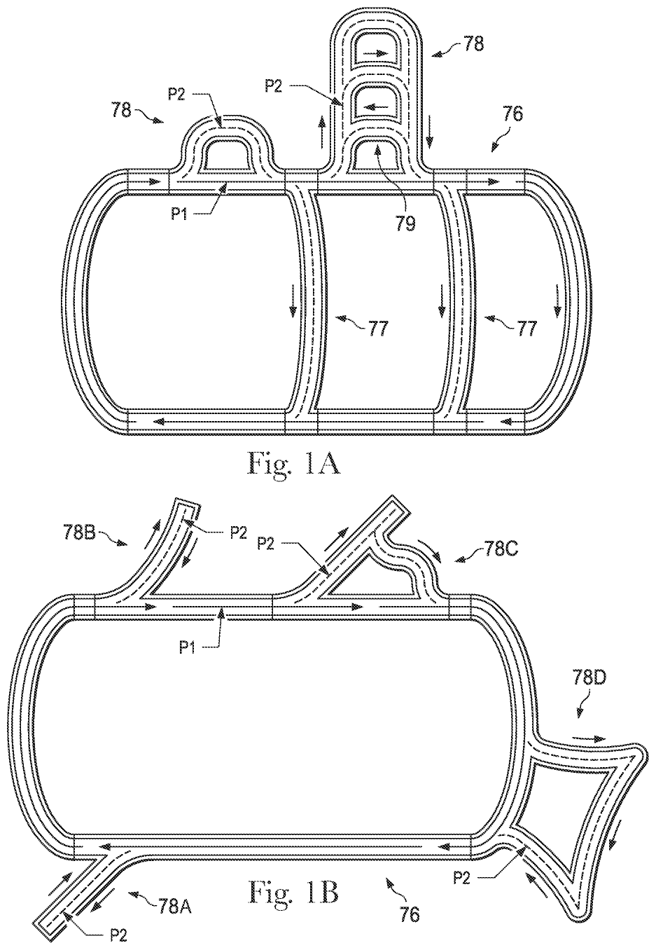

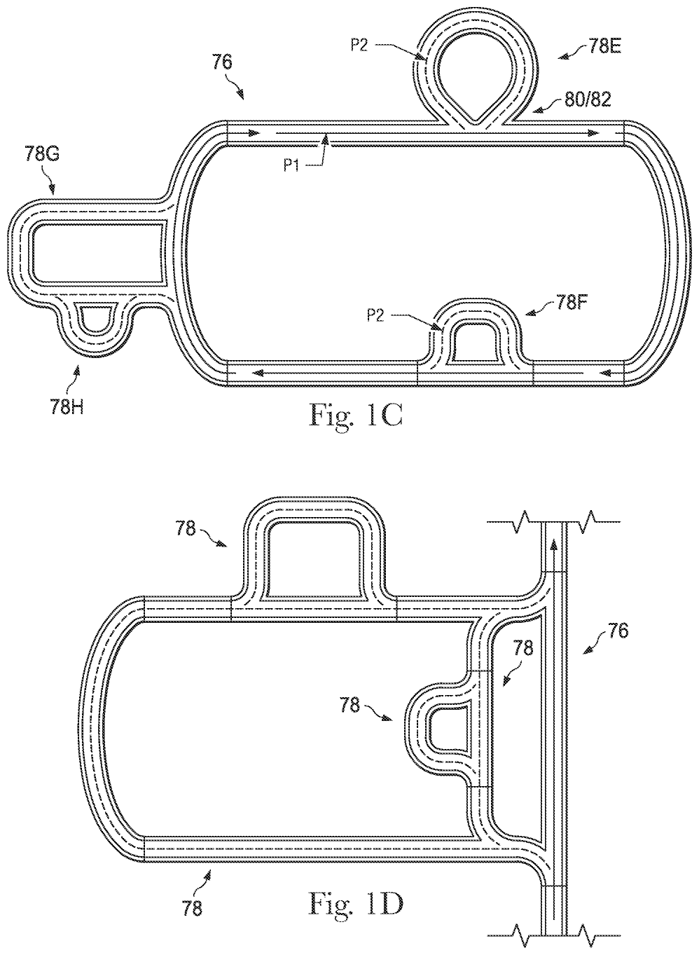

The term “interface point”, as used herein, refers to a specific location on a track. The interface point location is pre-selected, for the purpose of the product scheduling controller. Exactly one interface point can be defined along the track between adjacent unit operation station groups, such that it could be said that a unit operation station group has an upstream interface point located between the unit operation stations of the unit operation station group and the unit operation stations of an upstream unit operation station group, and that a unit operation station group has a downstream interface point located between the unit operation stations of the unit operation station group and the unit operation stations of a downstream unit operation station group. As an example, the unit operation stations 86 of FIG. 1 comprise a unit operation station group. This unit operation station group has an upstream interface point I2 (FIG. 1) and a downstream interface point I3 (FIG. 1). Elaborating on the same example, the unit operation stations 88 of FIG. 1 comprise a second unit operation station group. The second unit operation station group has an upstream interface point I3 (FIG. 1) and a downstream interface point I4 (FIG. 1). Thusly, an interface point may serve as both a downstream interface point for a first unit operation station group and an upstream interface point for a second unit operation station group. Interface points need not (and often do not) correspond to the location of ingress or egress switches. Interface points may be on either the primary transport path or the secondary transport path(s).

The term “joined to” as used throughout this disclosure, encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element.

The term “operation”, as used herein with respect to an activity that occurs at a unit operation station, includes transformations and inspections.

The term “packaging”, as used herein, means a structure or material that is at least partially disposed on or about a consumer product. “Primary packaging” means the container in which the consumer product is in direct contact and includes its closure, pump, cap, or other peripheral items. “Secondary packaging” means any additional materials that are associated with the primary packaging, such as, for example, a container such as a box or polymeric sleeve that at least partially surrounds, contains, or contacts the primary packaging.

The term “propellable”, as used herein, means able to be propelled in any manner. Vehicles can be propellable, for example, by gravity, or by a propulsive force which may be mechanical, electrical, magnetic, or other form of propulsion.

The term “route”, as used herein, refers to an ordered list of unit operation stations for a container-loaded vehicle to visit and operations to be completed at such unit operation stations in order to create finished products.

The term “simultaneous”, as used herein, not only means something that starts at the (exact) same time, but also something that may not start and/or end at the exact same time, but which takes place during the same time frame. One or more of the following may be specified to occur simultaneously in the systems and methods described herein: the routing of vehicles; the delivery of different vehicles to unit operation stations; the carrying out of operations at the same or different unit operation stations; and/or the process of (or any steps in the process of) creating a plurality of (the same or different) finished products in the same type of container or in different types of containers.

The term “system”, as used herein with respect to the track, refers to a (single) network on which one or more container-loaded vehicles can be routed to one or more unit operations. The tracks and paths in a system will, therefore, typically be joined (at least indirectly) to each other. In contrast, separate unconnected processing lines in the same building or facility, or in a different building or facility, would not be considered to comprise a system. Thus, two unconnected filling lines in the same building that are being operated to fill containers with different fluids would not be considered to comprise a system.

The terms “transformation”, as used herein, includes physical, chemical, and biological changes to a container and/or its contents. Examples of transformations include, but are not limited to: loading, dispensing, filling, mixing, capping, sealing, decorating, labelling, emptying unloading, heating, cooling, pasteurizing, sterilizing, wrapping, rotating or inverting, printing cutting, separating, pausing to allow mechanical settling or mechanical separation or chemical reaction, or etching. The term “transformation” does not include inspection of a container and/or its contents.

The term “unique”, as used herein to modify the term “route”, means the number, type, or sequence of unit operation stations or operations completed at the unit operation stations differs from that of another container-loaded vehicle.

The term “unit operation station”, as used herein, means a location where the container or its contents undergoes an operation which may be a transformation or an inspection. The types of transformations defined above may each be carried out at separate unit operation stations; or one or more transformations and/or inspections may be described as one operation that is carried out at a single unit operation station. In one non-limiting example of the latter, the transformations of uncapping, filling, and capping could be carried out at a single filling/capping unit operation station.

All percentages and ratios are calculated by weight of the total composition, unless otherwise indicated.

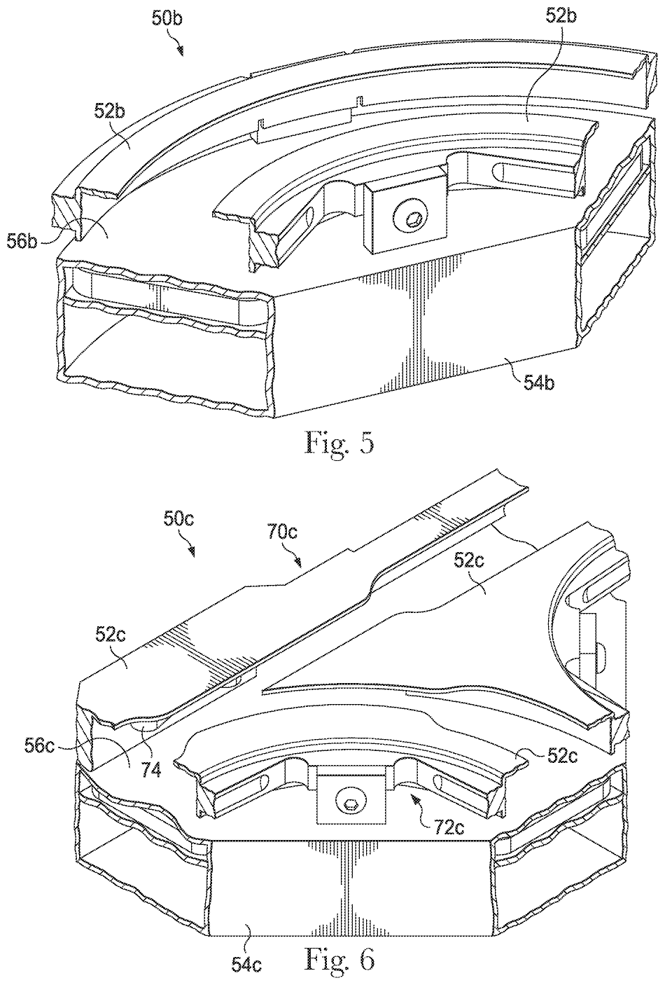

In connection with the views and examples of FIGS. 1-9 (including FIGS. 1A to 1D), wherein like numbers indicate the same or corresponding elements throughout the views, a track system 20 is shown in FIG. 1 to include a track 22 and a plurality of vehicles 24 that are propellable along the track 22. The track system 20 can comprise any suitable type of system. In some embodiments, the track system 20 can be a linear synchronous motor (LSM) based system that facilitates propulsion of the vehicles 24 along the track 22 using electromagnetic force (EMF). In other embodiments, the track system can be a system in which the vehicles are propelled in some other manner, such as by individual servomotors. In the embodiment shown, however the vehicles are propelled by a linear synchronous motor (LSM) based system.

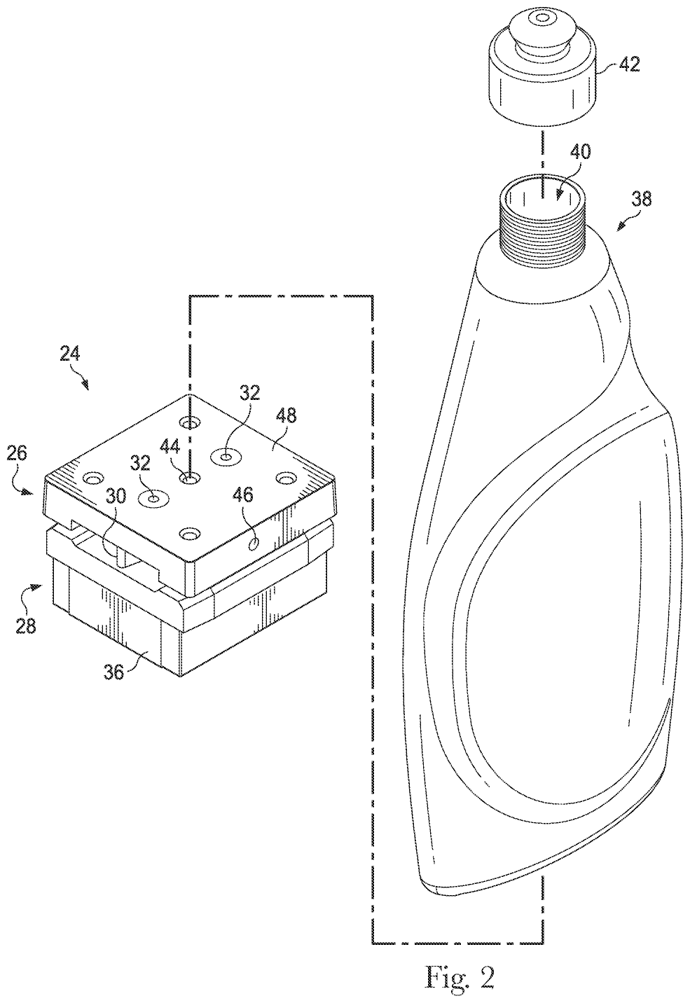

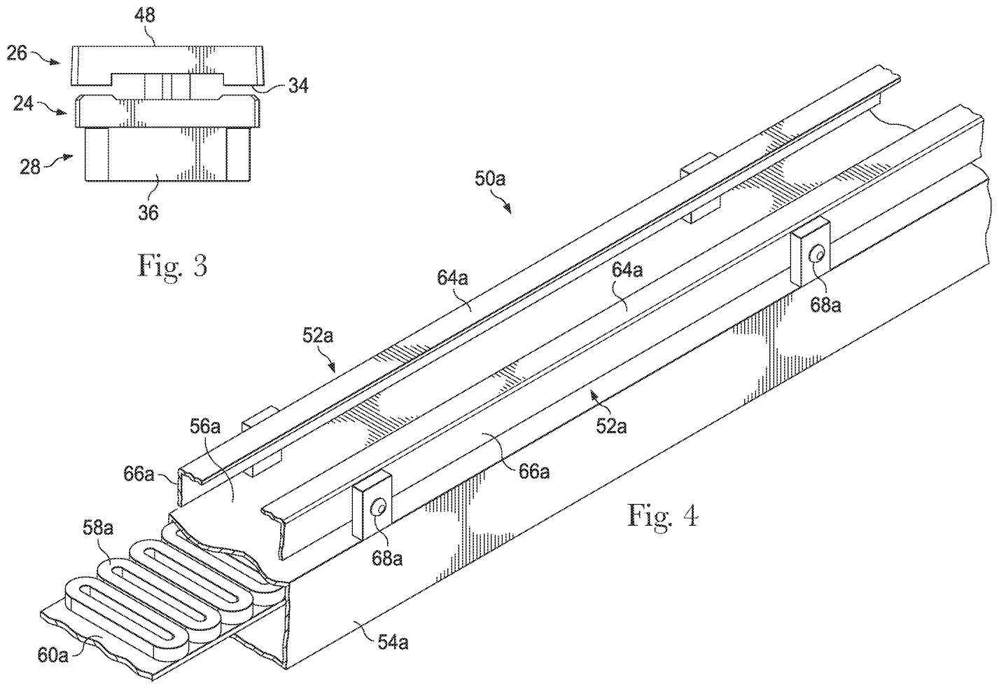

One of the vehicles 24 is illustrated in FIG. 2 and is shown to include an upper portion 26 and a lower portion 28 that are coupled together by a central rib 30. In one embodiment, the upper and lower portions 26, 28 can be releasably coupled together with fasteners 32. The upper and lower portions 26, 28 can be spaced from each other by the central rib 30. As illustrated in FIG. 3, the upper portion 26 can include a wear surface or running surface 34 that is adjacent to the central rib 30 and faces the lower portion 28. The lower portion 28 can include a magnet 36 that facilitates LSM propulsion of the vehicle 24 along the track 22. In one embodiment, the magnet 36 can be a magnet array having a central magnet that is formed of a south pole and sandwiched between two ends that are each formed as a north pole. It is to be appreciated that the vehicles 24 can be any of a variety of suitable alternative arrangements for facilitating LSM propulsion along a track system. Some examples of these alternative arrangements are described in U.S. Pat. Nos. 6,011,508; 6,101,952; 6,499,701; 6,578,495; 6,781,524; 6,917,136; 6,983,701; 7,448,327; 7,458,454; and 9,032,880.

A container 38 can be provided on the vehicle 24 for routing of the container 38 around the track 22 to facilitate filling of the container 38 with fluent material and/or performing other operations on the container and/or its contents. The container 38 can define at least one opening 40 for receiving and dispensing fluent material. When it is said that the container has an opening 40, embodiments with multiple openings (such as multi-compartment containers with separate closures or a single closure, press-tab vent and dispenser containers, and the like) are also included. There can be multiple containers on a single vehicle, or on different vehicles.

When there is more than one container on the track system 22, the containers 24 may be all of the same type or geometric form (that is, the containers are of the same size, shape, appearance, and have the same volume), or any of the containers may differ from the other in one or more of size, shape, appearance, or volume. When reference is made to the “shape” of a container, it is understood that this means the exterior shape of the container. When reference is made to the “volume” of a container, it is understood that this means the interior volume of the container. The multiple containers can be identified as first, second, third, etc. containers. On the track system at any given time, more than two containers may differ and/or hold fluent materials that differ from other containers. In some embodiments, there may be 3, 4, 5, 6, 7, 8, 9, 10, or more, different types of containers, or groups of different types of containers (that may differ from each other in container type and/or in the fluent materials contained therein) that are disposed along the track system at any given time.

A closure 42 can be joined to the container to close the opening 40 until it is desired to dispense the product from the container (that is, the closure “selectively seals” the opening). Closures include, but are not limited to: caps, such as snap caps, threaded-screw caps, caps comprising multiple parts like a hinge and top or a transition spout, glued-on caps (such as those used on some laundry detergent containers with spouts), caps that serve metering functions like oral rinse caps, pumps or triggers, and aerosol nozzles. The closures have a shape, a size, and appearance. Similarly to the containers, the closures may all be of the same type, or any of the closures may differ from others in one or more of shape, size, or appearance. The multiple closures can be identified as first, second, third, etc. closures.

It is to be appreciated that containers, as described herein, can be any of a variety of configurations and can be used across a variety of industries to hold a variety of products. For example, any embodiment of containers, as described herein, may be used across the consumer products industry and the industrial products industry, wherein said containers contain a fluent product. The containers may be filled in one or multiple filling operations to contain, after partial or complete intended filling, a portion, or multiple ingredients of, or all ingredients of, a finished product. Finished products may in part or whole be flowable or fluent.

Examples of finished products include any of the following products, in whole or part, any of which can take any workable fluent product form described herein or known in the art.

As further examples, any embodiment of containers, as described herein, may contain products or product elements to be used across additional areas of home, commercial and/or industrial, building and/or grounds, construction and/or maintenance. As further examples, any embodiment of containers, as described herein, may contain products or product elements to be used across the food and beverage industry. As still further examples, any embodiment of containers, as described herein, may contain products or product elements to be used across the medical industry.

The vehicles 24 can be configured to accommodate certain of the container types. As such, different vehicle types can be provided on the track 22 to allow for simultaneous routing of different container types along the track 22. The vehicles 24 are also not limited to conveying containers. In some cases, the vehicles 24 can be used for other purposes which may include, but are not limited to: delivering raw materials to a unit operation station; and delivering tools such as changeover tools and the like to various locations around the track system. For example, a vehicle may be used to carry a tool that removes labels from a decoration unit operation station.

Referring again to FIG. 1, the track 22 can be formed by a plurality of straight portions 50a, a plurality of curved portions 50b, and a plurality of transition portions 50c. One of the straight portions 50a is illustrated in FIG. 4 and is shown to include a pair of rails 52a that are coupled with a base 54a. The base 54a can include a running surface 56a and a plurality of conductive propulsion coils 58a disposed beneath the running surface 56a. The conductive propulsion coils facilitate routing of the vehicles along the track 22 in a direction of travel. Each conductive propulsion coil defines a common axis and comprises a conductor having one or more turns that are disposed about the common axis. The respective common axes of the plurality of conductive propulsion coils may be substantially parallel with one another and substantially orthogonal to the desired direction of travel. The plurality of coils 58a can be mounted on an underlying substrate 60a, which in some embodiments can be a printed circuit board (PCB). The plurality of coils 58a can be electrically coupled with a power source (not shown) that can facilitate energization of the power coils 58a to propel the vehicles 24 along the track 22. The propulsion coils 58a may be disposed on at least one of the opposing sides of the magnet of a vehicle to facilitate propulsion of the vehicle along the track system. A control system 62 (FIG. 1) can control the energization of the coils 58a to control the propulsion of the vehicles 24 along the track 22. In one embodiment, each coil 58a can be electrically coupled to a transistor (e.g., a MOSFET or IGBT) which is coupled with an output of an “H-bridge”. The control system 62 can control the propulsion of each of the vehicles 24 along the track 22 through operation of the H-bridge which controls the amount and direction of current in each coil 58a. Hall effect sensors (not shown) can be distributed along the base 54a to facilitate detection of the magnetic field produced by the vehicles 24 on the track 22. The control system 62 can be in electrical communication with the Hall effect sensors to facilitate selective control of various propulsion characteristics of the vehicles 24 (e.g., speed, direction, position).

Each rail 52a can have an upper portion 64a and a side portion 66a that cooperate together to form an L-shape when viewed from the end. Each of the rails 52a are coupled at the side portions 66a to the base 54a with fasteners 68a. When each vehicle 24 is provided on the track 22, the upper portions 64a of each of the rails 52a can extend into the space between the upper and lower portions 26, 28 of the vehicle 24 such that the wear surface 34 of the upper portion 26 of the vehicle 24 can ride on the upper portion 64a of the rails 52a. In alternative embodiments, the wear surface can have wheels extending therefrom, and the wheels can travel over the upper portion 64a of the rails 52a. The side portions 66a of each of the rails 52a can extend along opposite sides of the lower portion 28 of the vehicle 24. During operation of the vehicles 24 along the track 22, the rails 52a can facilitate guidance of the vehicles 24 along the running surface 56a while suspending the vehicle 24 above the running surface 56a enough to allow the vehicles 24 to be magnetically propelled along the track 22.

Referring again to FIG. 1, the track 22 can include a primary transport portion 76 and at least one (alternatively, a plurality of) secondary transport portions 78 that are provided around, and extend from, the primary transport portion 76. The primary transport portion 76 can define a primary path P1 for the vehicles 24. Each of the secondary transport portions 78 can define a secondary path P2 for the vehicles 24 that is intersected by the primary path P1 at an ingress location 80 and an egress location 82. The vehicles 24 can enter and exit each of the secondary transport portions 78 at the associated ingress and egress locations 80, 82, respectively. The vehicles 24 can travel clockwise or counter-clockwise around the primary transport portion 76 and the secondary transport portion(s) 78. In some embodiments, it is possible for some of the vehicles 24 to travel clockwise, and some of the vehicles to simultaneously travel counter-clockwise for a portion of their routes or vice versa, but care must be taken so travel in opposing directions does not result in a collision between the vehicles.

Each of the secondary transport portions 78 can have disposed therealong one or more unit operation stations of any of the types of unit operation stations described in the above definition of “unit operation stations” (and the definitions of transformation and inspection included therein). There can be any suitable number of unit operation stations. Generally, there will be two or more unit operation stations (e.g., 2, 3, 4, 5, . . . up to 100, or more). The unit operation stations may be in any suitable arrangement along the secondary transport portions 78. The unit operation stations can be arranged with a single unit operation station along one or more of the secondary transport portions, or a group of unit operation stations along one or more of the secondary transport portions.

FIG. 1 shows one non-limiting embodiment of an arrangement of unit operation stations on the secondary transport portions 78. In the embodiment shown in FIG. 1, each of the secondary transport portions 78 comprises one of a plurality of container loading stations 84, a plurality of combined filling/capping stations 86, a plurality of decorating stations 88, or a plurality of unloading stations 90 (e.g., collectively “the unit operation stations”). In this embodiment, each of the unit operation stations 84, 86, 88, 90 located at a particular secondary transport portion 78 can be disposed along different unit transport segments 91 that are arranged in parallel. The vehicles 24 can be selectively routed among the secondary transport portions 78 to facilitate bottling of fluent material within a plurality of the containers 38.

It is to be appreciated that there can be significantly more vehicles 24 on the track 22 than are illustrated in FIG. 1. There can also be significantly more vehicles 24 than unit operation stations 84, 86, 88, 90. Each of the vehicles 24 are independently routable along the track 22 to facilitate simultaneous delivery of at least some of the containers 38 to different ones of the unit operation stations 84, 86, 88, 90.

When the vehicles 24 are not stationed at one of the unit operation stations 84, 86, 88, 90, at least one (or more, e.g., 2, 3, 4, 5, . . . up to 100, or more) of the vehicles 24 can continuously circulate around the primary transport portion 76, thus bypassing the secondary transport portions 78 while waiting to be diverted thereto. The primary path P1 can be in the form of a closed loop to facilitate the circulation of the vehicles 24. The primary path P1 may also be described as circuital or continuous. The primary path P1 can be of any suitable configuration. Suitable configurations for the primary path P1 include, but are not limited to: circular paths, elliptical paths, or in a path that comprises both linear portions and curvilinear portions. Non-limiting examples of the latter types of paths include: race track configured paths, generally rectangular paths with rounded corners (as shown in FIG. 1), and other closed loop paths. The primary path P1, of course, is not closed to vehicles entering or leaving the primary path, since it does have ingress and egress portions for container-loaded vehicles to be diverted therefrom onto the secondary paths P2.

In some cases, as shown in FIG. 1A, the primary path P1 may further comprise one or more sub-loops 77 that are disposed inside of the main closed loop of the primary transport portion 76, and form a path between portions of the main closed loop. The sub-loop 77 may form a path between opposing portions of the main closed loop 76. However, sub-loops 77 may alternatively form a path between non-opposing portions of the main closed loop 76. There are, of course, ingress and egress portions to the sub-loop(s). The sub-loops 77 provide a path for at least some of the container-loaded vehicles to recirculate without traveling completely around the closed loop of the primary path P1.

There can be any suitable number of secondary paths P2 (e.g., 1, 2, 3, 4, 5, . . . up to 100, or more). In some cases, a single secondary path having a ladder configuration (described below), with two rungs may be sufficient. Generally, there will be two or more secondary paths (at least one for filling and one for unloading). When there is more than one secondary path P2, these can be referred to as first, second, third, etc. secondary paths.

It is possible that one or more types of unit operation stations could be located along the primary transport portion 76. However, to alleviate congestion on the primary transport portion 76 and allow one or more of the vehicles 24 to continuously circulate along the primary path P1, the primary transport portion 76 can be devoid of some or all unit operation stations (i.e., 84, 86, 88, 90), and the unit operation stations can instead be located at the secondary transport portions 78, as described above. Alternatively, the primary transport portion 76 may only have fast cycle stations located along the same. The vehicles 24 are therefore diverted off of the primary transport portion 76 to undergo the operations performed by the unit operation station 84, 86, 88, 90 and thus do not interfere with the flow of traffic on the primary transport portion 76. (Of course, in other embodiments, one or more unit operation stations can be located along the primary transport portion 76, and other unit operation stations may be located on the secondary transport portions 78.)

As will be described in further detail below, the control system 62 can coordinate operation of the track 22, routing of each of the vehicles 24, as well as operation of each of the unit operation stations 84, 86, 88, 90 to efficiently and effectively fulfill an order of finished products. The control system is, thus, in communication with the track 22, the vehicles 24, and the unit operation stations 84, 86, 88, 90. The coordination of the operation of these components can include, for example, vehicle identification, vehicle scheduling, collision avoidance, route selection, outage reporting, and the like.

Each of the unit operation stations 84, 86, 88, and 90 in the embodiment shown in FIG. 1 will now be more fully described. The container loading stations (or simply “loading stations”) 84 can be configured to facilitate loading of an empty container (e.g., 38) and/or a closure therefor onto a vehicle 24 located at the container loading station 84. It is to be appreciated that the container loading station 84 can comprise any of a variety of automated and/or manual arrangements that facilitate loading of a container and/or a closure onto a vehicle. Loading can be done manually, statically such as by a gravity feed chute with optional gate, or with a mechanical motion device. Suitable mechanical motion devices include, but are not limited to: independently actuatable automatic arms, pneumatic arms, robots, transfer wheels, and other mechanical moving elements. In one embodiment, the container loading stations 84 can each include a robotic arm (not shown) that retrieves the container 38 and/or a closure from a storage area and places the container 38 and/or a closure on the vehicle 24. To facilitate grasping of the containers 38 and/or closures, each robotic arm can have a robotic mandible, a suction end, or any of a variety of suitable additional or alternative arrangements that enable grasping of the containers 38 and/or closures. Once the container 38 and/or a closure are in place on the vehicle 24, a vacuum line (not shown) can be inserted in the primary port 46 (FIG. 2) to draw a vacuum on the vacuum port 44 thereby temporarily securing the container 38 and/or a closure to the vehicle 24. The vacuum line can then be removed from the primary port 46, thereby allowing the associated valve (not shown) to close to maintain the vacuum on the container 38 and/or a closure.

A filling unit operation station is used to dispense fluent material into at least some of the containers. A filling unit operation station is not required to fill the containers to any particular level (such as to a “full” level). The filling unit operation station can dispense any suitable fluent material into the container. In some cases, the filling unit operation station can dispense a composition into the container that comprises all of the ingredients of the finished product. Alternatively, the filling unit operation station can dispense a base composition into the container, and the container can be sent to another filling unit operation station to have other ingredients added thereto in order to form a finished product. Thus, some filling unit operation stations may only dispense portions of the finished product composition. Such portions include, but are not limited to: water, silicone (such as for use as a conditioning agent, or the like), dyes, perfumes, flavors, bleach, anti-foam agents, surfactants, structurants, etc. If the ingredients are separately added, they can be mixed together at any suitable unit operation station.

In addition, although some filling unit operation stations may only be configured to dispense one type of fluent material, the filling unit operation stations are not limited to dispensing only one type of fluent material (e.g., one color of dye, etc.). In some cases, one or more of the filling unit operation stations can be configured to dispense different ingredients (such as through a different fluent material supply and nozzle). For example, the same filling unit operation station could dispense a green finished composition, a blue finished composition, and a red finished composition; or, it could dispense a green dye, a blue dye, and a red dye. In such cases, at least two different types of containers (e.g., a first, a second, a third, etc. container) may receive one or more (or all) of the ingredients for their finished compositions from the same fluent material dispensing unit operation station, or from the same type of fluent material dispensing unit operation station.

In some embodiments, the closure 42 may be transported on the container 40. In such embodiments, when the vehicle 24 arrives at the filling/capping station 86, the vehicle 24 can first be routed to the capping portion 94. The capping arm 98 can remove the closure 42 from the container 38 and can move to the retracted position while holding the closure 42. The vehicle 24 can then be routed to the filling portion 92 for filling of the container 38 with fluid. Once the container is filled, the vehicle 24 can return to the capping station 94 where the capping arm 98 secures to the closure 42 to the container 38. In other embodiments, the closure 42 can be transported to the filling/capping station 86 on the same vehicle as the container 38, but not on the container (for example, on the same vehicle but adjacent to the container). In other embodiments, the closure 42 can be transported to the filling/capping station 86 on a different vehicle (e.g., a separate vehicle) from the vehicle transporting the container 38. When the closure is transported on a vehicle, it can be held by vacuum (or in some other suitable manner) and sent to any of the finished product unit operation stations, if desired. For example, it may be desirable to send the closure 42 to a decoration station for decorating the closure. In yet other embodiments, the closure 42 might not be transported with the empty container 38, but instead can be provided to the container 38 upon its arrival at the capping portion 94 (i.e., after the container 38 is filled with fluent material). It is to be appreciated that the filling/capping stations 86 can include any of a variety of additional or alternative automated and/or manual arrangements that facilitate filling and capping of a container.

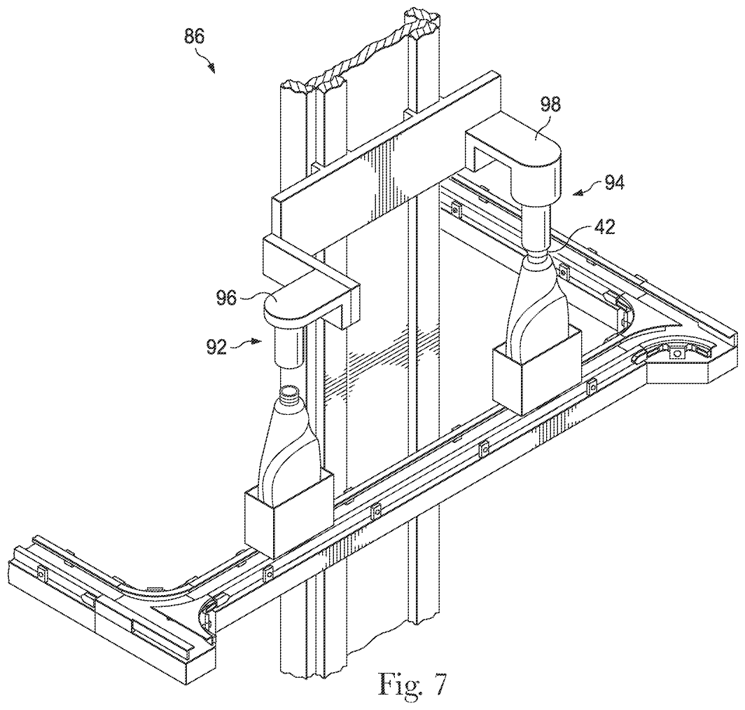

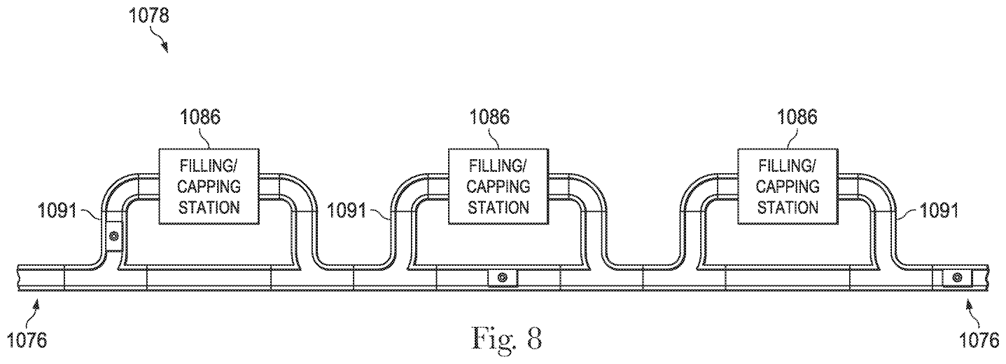

An alternative embodiment of a secondary transport portion 1078 is illustrated in FIG. 8 and is shown to include a plurality of filling/capping stations 1086 that are similar to or the same as in many respects as the filling/capping stations 86 shown in FIGS. 1 and 7 and described above. However, the filling/capping stations 1086 can b e disposed along different unit transport segments 1091 that are arranged in series along a primary transport portion 1076 of a track (e.g., 22). It is to be appreciated that the other unit operation stations can additionally or alternatively be disposed along different unit transport segments 1091 that are arranged in series.

The decoration stations 88 can be configured to facilitate labelling, printing, or otherwise decorating the containers 38 (and optionally also doing the same to their closures). In one embodiment, at least one of the decoration stations 88 can include a printer (not shown) that prints labels for application to the containers 38.

In some embodiments, the containers 38 can be provided into packaging that is designed to present the containers 38 for sale at a merchant. In such packaging, the containers 38 can be offered for sale individually or packaged with one or more other containers or products, which together form an article of commerce.

The track system 20 can comprise any suitable number and/or type of inspection station(s). For example, in FIG. 1, the track system 20 can include a first scanner 100 and a second scanner 102 that are each configured to scan passing containers 38. The first scanner 100 can be located between one of the ingress locations 80 and the filling/capping station 86 and can scan each passing vehicle 24 to determine if the container 38 is present. The second scanner 102 can be located between the decoration stations 88 and the unloading stations 90 and can scan each passing vehicle 24 to determine whether the container 38 disposed thereon is ready for packaging by the unloading stations 90.

The first and second scanners 100, 102 can be any of a variety of scanners for obtaining information from the vehicles 24 and/or the containers 38 such as, for example, an infrared scanner. The first and second scanners 100, 102 can also be configured to facilitate reading of a variety of data from the container 38 such as QR codes or UPC barcodes, for example.

It is to be appreciated that the track system 20 can facilitate dispensing different types of fluent materials into various types of different containers at the same time. (Of course, the start time and finish time of dispensing into the different containers may, but need not, coincide exactly. The dispensing into the different containers may only at least partially overlap in time.)

In addition, in some cases, one or more containers may not be filled with fluent material that is used to make a finished product. For example, one or more containers may be used to receive fluent material that is cleaned or flushed from one or more nozzles at a filling unit operation station, and this fluent material can thereafter be disposed of or recycled.

As will be described in more detail below, the particular container types and fluent materials provided for each vehicle 24 can be selected by the control system 62 to fulfill a particular production schedule, and each vehicle 24 can be independently and simultaneously routed along a unique route among the unit operation stations (such as 84, 86, 88, 90) to facilitate loading and filling of the containers 38. The unique route for each vehicle 24 can be selected by the control system 62 based, at least in part, upon the vehicle type (i.e., the type of container or containers the vehicle 24 is configured to accommodate), the unique routes selected for the other vehicles 24, and/or the type of finished product(s) needed by the unloading station 90 for packaging, for example. It is to be appreciated that the track system 20 can facilitate filling of different types of containers with different types of fluid more efficiently and effectively than conventional arrangements. For example, conventional arrangements, such as linear motor filling lines, typically only allow for filling of one type of container with one type of fluid at a time. As such, individual systems are oftentimes required for each container and fluid being manufactured which can be expensive and time consuming. In addition, converting these systems to use a different container and/or fluid can also be expensive and time consuming. The track system 20 can therefore be a solution that allows for manufacture of different types of filled containers less expensively and in a less time consuming manner than these conventional arrangements.

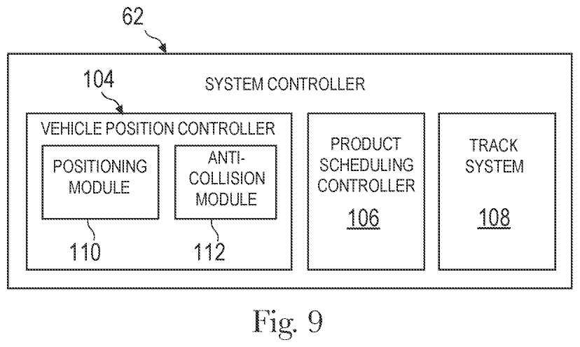

Referring now to FIG. 9, the control system 62 can include a vehicle position controller 104, a product scheduling controller 106, and a track system controller 108, that are communicatively coupled with each other and can cooperate to facilitate producing finished products. The vehicle position controller 104 can include a positioning module 110 and an anti-collision module 112. The positioning module 110 can facilitate positioning of the vehicles 24 at designated locations along the track 22. Each of the vehicles 24 can have a unique identifier associated with it (uniqueness only needs to be relative to the other vehicles on the track) and with which the vehicle positioning module 110 can identify it. The vehicle position controller 104 can receive desired location coordinates from the track system controller 108 for the vehicles 24. The vehicle position controller 104 can move the vehicles 24 along the track 22 based upon the location coordinates for each vehicle 24.

The control system 62 can be any suitable computing device or combination of computing devices (not shown), as would be understood in the art, including without limitation, a custom chip, an embedded processing device, a tablet computing device, a personal data assistant (PDA), a desktop, a laptop, a microcomputer, a minicomputer, a server, a mainframe, or any other suitable programmable device.

The computing device can include any known processor that can be any suitable type of processing unit.

The computing device can also include one or more memories, for example read only memory (ROM), random access memory (RAM), cache memory associated with the processor, or other memories such as dynamic RAM (DRAM), static ram (SRAM), programmable ROM (PROM), electrically erasable PROM (EEPROM), flash memory, a removable memory card or disk, a solid state drive, and so forth. The computing device can also include any type of storage media known. Other types of media are listed in US Publication Number 2018-0072445 A1 filed Sep. 8, 2017, Burkhard et al. or in US Publication Number 2018-0076069 A1 filed Sep. 8, 2017, Burkhard et al.

Network and communication interfaces can be configured to transmit to, or receive data from, other computing devices across a network. The network and communication interfaces can be an Ethernet interface, a radio interface, a Universal Serial Bus (USB) interface, or any other suitable communications interface and can include receivers, transmitters, and transceivers. For purposes of clarity, a transceiver can be referred to as a receiver or a transmitter when referring to only the input or only the output functionality of the transceiver. Example communication interfaces can include wired data transmission links such as Ethernet and TCP/IP. The communication interfaces can include wireless protocols for interfacing with private or public networks.

The product scheduling controller 106 can be configured to assign a container type and fluent material type (e.g., a finished product) for each empty vehicle 24. The product scheduling controller 106 can also be configured to assign a desired route that achieves the assigned finished product. The track system controller 108 can be configured to route the vehicles 24 around the track 22 and operate the unit operation stations 84, 86, 88, 90 based upon the finished product and route assigned to the vehicles 24.

The control system 62 may be configured as a central assignment mechanism that pre-assigns independent routes for the vehicles based on demand data. The control system 62: receives demand for finished products to be made on the track system; determines a route for a vehicle, wherein the route is determined based on a status of one or more unit operation stations; and causes a vehicle to be propelled to progress along the determined route to create one or more of the demanded finished products, and delivers the finished products to an unloading station. It should be understood that these steps can be taking place in the above order, or in any order, provided that at least some demand for finished products to be made is first received. Generally, when there are multiple vehicles being routed, the control system can be performing such steps for the different vehicles. These vehicles may be at different stages of going through these steps at any given time (and the control system can be executing any of these steps for the various vehicles at any given time).

The status of the unit operation station(s) can comprise: (a) the state of readiness of a unit operation station (whether the unit operation station is broken down, or not); (b) one or more capabilities of the unit operation station (that is, a description of the unit operation(s)); (c) information concerning operations expected or scheduled to be completed at one or more unit operation stations in the future (including the progress of other vehicles along their routes); (d) information concerning the capacity utilization of the unit operation station (that is, how much of its capacity is used relative to its full capacity, or conversely how often it is idle relative to its full capacity); (e) information concerning the capacity utilization of other unit operation stations (utilization of other unit operation stations (similar or dissimilar)); (f) information concerning the availability of raw materials (e.g., fluent material(s), labels, etc.) to the unit operation station; and (g) information concerning expected maintenance activities involving the unit operation station.

The determined route may, in some cases, have one or more constraints on arriving at one or more unit operation stations before one or more other vehicles or after one or more other vehicles. In other cases, the determined route may not have any constraints on arriving at one or more unit operation stations before one or more other vehicles or after one or more other vehicles. The determined route is determined based on status information of a vehicle. Such status information may include: the vehicle's container-holding interface type, maximum velocity of the vehicle, maximum acceleration of the vehicle, maximum container weight that can be held by the vehicle, maximum container size, and any other relevant information about the vehicle. The determined route can be selected from a subset of all possible routes, and more particularly is selected from a set of all possible routes that will result in creating a demanded finished product. The determined route is selected by comparing potential routes where such comparison takes into account the utilization or capacity of one or more unit operation stations and the selected route may be selected to best utilize the capacity of one or more unit operation stations.

The determined route may take into consideration the routes assigned to other vehicles 24, including the extent to which the other vehicles have actually progressed along their planned routes, so as to avoid congestion caused by excessive vehicles reaching a similar location at a similar time, and so as to ensure vehicles will arrive in a desired sequence where appropriate.

The determined route may be determined using an algorithm (described as follows), where the algorithm may comprise a recursive method so as to be applicable to a wide range of track configurations and unit operation station configurations without requiring modifications to the algorithm's recursive method. The algorithm may implement a system where unit operation stations demand partially or completely finished products from other unit operation stations so as to enable the unit operation stations to contribute towards creating finished products specified in the step of receiving demand for finished products to be made. The demand from the unit operation stations may describe needed products and times when those products may be needed. (The loading unit operation stations will, however, typically receive demand for vehicles, rather than partially or completely finished products.) The demand from the unit operation stations makes it possible for the route-determining algorithm to only consider routes connecting unit operation stations with appropriate demand, substantially reducing the time and processing power required to determine a route as compared to an algorithm that would evaluate the merits of every possible way to route a vehicle along the track. Such an algorithm could solve the problem of determining a best route from many possible ways to route a vehicle along a track (100 billion, 1 trillion, or many more ways being possible in some embodiments) in a short period of time (e.g., less than one second), or a very short period of time (100 milliseconds, 50 milliseconds, 5 milliseconds, or less in some embodiments). Such an algorithm may take the form of several embodiments, some of which may also assign a quantity or priority to the demanded products at unit operation stations.

An example of the vehicle position controller 104, the product scheduling controller 106, and the track system controller 108 cooperating to create a finished product will now be described. First, when the vehicle 24 is empty (either due to system start-up or being emptied at the unloading station), the track system controller 108 can request, from the product scheduling controller 106, the next finished product to be assigned to the vehicle 24. The product scheduling controller 106 can assign a finished product to the vehicle 24 and can provide the desired route for the vehicle 24 to take to complete the finished product. The track system controller 108 can then provide coordinates to the vehicle position controller 104 that will route the vehicle 24 to one of the container loading stations 84. The vehicle position controller 104 then routes the vehicle 24 to the container loading station 84 (via the designated coordinates) and notifies the track system controller 108 when the vehicle 24 has reached its destination. The track system controller 108 can then facilitate operation of the container loading station 84. After the container 38 is loaded onto the vehicle 24, the track system controller 108 can provide coordinates to the vehicle position controller 104 that will route the vehicle 24 to one of the filling/capping stations 86. The vehicle position controller 104 then routes the vehicle 24 to the filling/capping station 86 (via the designated coordinates) and notifies the track system controller 108 when the vehicle 24 has reached its destination. The track system controller 108 can then facilitate operation of the filling/capping station 86. After the container 38 is filled and capped, the track system controller 108 can provide coordinates to the vehicle position controller 104 that will route the vehicle 24 to one of the decoration stations 88. The vehicle position controller 104 then routes the vehicle 24 to the decoration station 88 (via the designated coordinates) and notifies the track system controller 108 when the vehicle 24 has reached its destination. The track system controller 108 can then facilitate operation of the decoration station 88. After the container 38 is decorated, the track system controller 108 can provide coordinates to the vehicle position controller 104 that will route the vehicle 24 to one of unloading stations 90. The vehicle position controller 104 then routes the vehicle 24 to the unloading station 90 (via the designated coordinates) and notifies the track system controller 108 when the vehicle 24 has reached its destination. The track system controller 108 can then facilitate operation of the unloading station 90. After the container 38 is removed from the vehicle 24, the track system controller 108 can request, from the product scheduling controller 106, the next finished product to be assigned to the vehicle 24.

In some embodiments, the track system controller 108 can deviate the vehicle 24 from the desired path (assigned by the product scheduling controller 106) to overcome certain problems, such as a traffic jam, sequencing violation (sequencing is described below), and/or a defect or reject condition (e.g., bottle missing, cap missing, cap misaligned, etc.). The deviated path can be determined by the product scheduling controller 106 and/or the track system controller 108.

It is to be appreciated that the vehicle position controller 104, the product scheduling controller 106, and the track system controller 108 can facilitate simultaneous routing of the vehicles 24 around the track 22 such that the containers 38 are at various stages of production. To facilitate effective and efficient simultaneous routing of the vehicles 24, the vehicle position controller 104, the product scheduling controller 106, and the track system controller 108 can share information about the vehicles 24 and/or containers 38. For example, the track system controller 108 can share, with the product scheduling controller 106, the positions of the vehicles 24, the production status of each container 38, and/or any route deviations. The product scheduling controller 106 can share, with the track system controller 108, the finished product and route assignments for the vehicles 24.

As described above, the product scheduling controller 106 can assign a container type, a closure type, a fluent material type, a decoration type, and a route for each empty vehicle 24 identified by the track system controller 108. It is to be appreciated that although this embodiment describes assignment of a container type, a closure type, a fluent material type, and a decoration type, other embodiments may specify other finished product attributes. Other finished product attributes may include values related to the dimensions of a container or any part or parts thereof, values related to the mass of one or more parts of the product at one or more stages of completion including the finished product, fill quantity or level, or additional attributes similar to those previously or subsequently described such as a front label type and a back label type. Still more other finished product attributes may include targets or acceptable ranges of values for any one or more of the aforementioned finished product attributes or other finished product attributes. Furthermore, other finished product attributes may include parameters related to setup of unit operation stations to be used during operating on the finished product specified (for example, bottle height will dictate the height to which a filler nozzle will be adjusted).

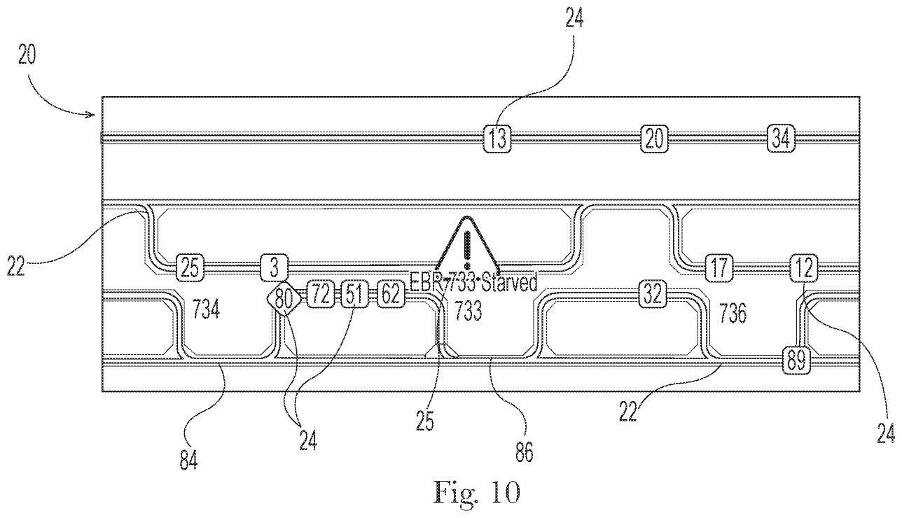

The screen shot of FIG. 10 represents a portion of a track system 20 including a track 22 and a plurality of vehicles 24 that are propellable along the track 22. The track 22 has one or more unit operation stations 84, 86. As shown in FIG. 10, the track system 20 comprises a multi-dimensional warning system that incorporates the individual vehicles 24, the unit operation systems 84, 86, and the track 22. This is exemplified by the alarm 25 indicating that unit 733 is starved. As shown in FIG. 10, each vehicle 24 may be assigned an identification number and its status may be indicated by one or more colors.

The multi-dimensional warning system may have tangible alarms or triggers or non-tangible alarms or triggers. The tangible triggers and the non-tangible triggers may be on a. one or more individual vehicles, b. one or more individual unit operation systems, and c. one or more portions of the track.

Nonlimiting triggers (tangible and non-tangible) on the vehicle may be velocity, position, presence on the track, status of being under the influence of a command to move from its present position, contact sensor on the vehicle, distance sensor on the vehicle, a distance detection between the vehicle and another vehicle or another item on the track, or a combination thereof. The multi-dimensional warning system may utilize existing equipment on the vehicles such as magnets to determine velocity and placement. Additionally the system may utilize cameras and qr codes on the vehicles. Further, the vehicles may have wheels that utilize encoders to determine distance.

The multi-dimensional warning system may comprise a trigger or alarm for a plurality of vehicles. The vehicles may be grouped in the system such that an alarm is raised if there are, for example, a number of vehicles in a particular region of the track exceeding less than a minimum number, or the absence of any vehicles in a particular region of the track from the grouping. An alarm may also be raised if the maximum velocity target of a vehicle in a particular region or group is exceeded or alternatively if the minimum velocity target of a vehicle in a particular region is not met. An alarm may also be raised if the average velocity of a plurality of vehicles or a group has changed in either direction by more than a predetermined percentage such as, for example, 5%.

Nonlimiting triggers (tangible and non-tangible) on the unit operations may include, dependent upon the unit operation system, the status of the unit operation system. For example, for filling unit operation systems, the trigger may relate to source material properties such as availability, pressures during filling versus target pressures, material temperatures versus target temperatures, and nozzle conditions (e.g. potential splashback on nozzle). It is understood by one of skill in the art that target settings (pressures, temperatures . . . ) may vary depending on the material being filled. Other triggers may include visible or audible alarms or graphics showing, for example, which nozzle in a multi-nozzle system has raised an alarm.

Nonlimiting triggers (tangible and non-tangible) on the packing units may include, for example, proper spacing between containers for the given containers, proper pressure grip of the packing units dependent on the desired pressure, presence of the container vehicles.

Nonlimiting triggers (tangible and non-tangible) on the capping units may include, for example, detection and/or presence of a cap, torque applied during capping for a given set point, grip strength applied, detection of a collision between a vehicle and the capping unit.

Nonlimiting triggers (tangible and non-tangible) on the track may include, for example, vehicle speeds at vulnerable sections (turns, switches). At these junctures, vehicle speeds may cause container, the vehicle, or the track, to be damaged by exceeding setpoints. The track may comprise a plurality of cameras. Further, the use of a linear motor track enables positioning data which is utilized to determine when a coil should be activated. This allows for proper tracking on the track for each vehicle.

Unlike traditional manufacturing that may utilize individual alarms at individual unit operations, it has been found that by creating a multi-dimensional warning system that is integrated with the overall CPU (controls system), one can create a system wherein the system can proactively respond to an alarm by adjusting one or more variables within the overall system. Therefore allowing the controller to deviate one or more vehicles from their desired path to overcome certain problems, such as a traffic jam, and/or a defect or reject condition (e.g., bottle missing, cap missing, cap misaligned, etc.). Additionally, by integrating all the warning systems with the CPU, one can detect unit operation issues before they occur. Said otherwise, the warning system allows one to utilize the behavior of the vehicles to anticipate growing issues even before an actual alarm is raised. This allows one to correct for the growing issue before the triggering of an alarm or alternatively, to have an abundance of data accessible to determine the root cause of an issue when an alarm is raised. Proactively eliminating issues before they adversely affect production rates leads to a reduction in downtime and an increase in productivity. For example, a vehicle may raise an alarm regarding one or more unit operations. The system may then re-route the other cars while the unit operation is being repaired. Alternative, the system may slow down cars to a unit operation instead of re-routing.

In an example, if the track becomes damaged, the system may shut down a portion of the track to protect that portion of the track. The system may, for example computer re-route vehicles to avoid the portion of the track that is damaged.

The multi-dimensional warning system is particularly of use in a manufacturing system that utilizes a plurality of different containers that are different shapes and sizes and fills different containers with different formulations that may or may not necessitate visiting each unit operation. In essence, the proposed manufacturing system is equivalent to running a plurality of manufacturing lines in a single line making a plurality of products at the same time. Thus, each vehicle may need to move at different velocities due to either the container on the vehicle or the location of the vehicle on the track.

Further because not every vehicle must visit each unit operation, the use of a multi-dimensional warning system allows for rerouting of vehicles if a portion of the track is down such that some vehicles may be rerouted and continue to manufacture their intended product while other vehicles may be placed in a holding pattern while the necessary unit operation is repaired thereby allowing the manufacturing of certain products to go unhindered. This is in contrast to a traditional system wherein all of the vehicles would be forced to stop and wait in an assembly line fashion.

Due to complex nature of such manufacturing system, some problems may be difficult or nearly impossible to detect without a multi-dimensional warning system that can utilize the behavior of vehicles and/or conventional unit operation alarms to identify problems and immediately take action to resolve them or direct an operator to resolve them.

For example, a manufacturing production may comprise a plurality of unit operation systems and when one of said unit operation systems is not functioning normally, the manufacturing production is still producing product, albeit at a slightly reduced throughput. Such a small reduction in throughput would be difficult to be observed directly. Even the use of throughput meters would not explain why the loss in throughput is occurring. The multi-dimensional warning system both indicates that a problem can impact throughput and suggests where/how to resolve said problem.

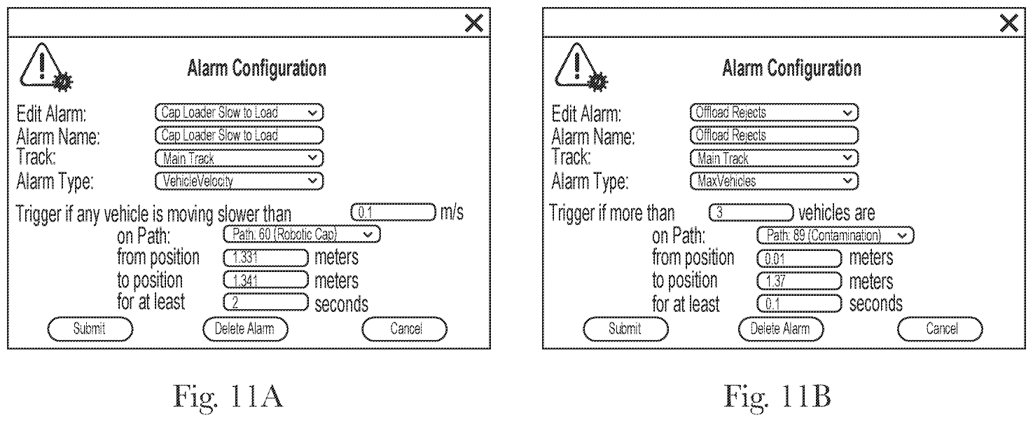

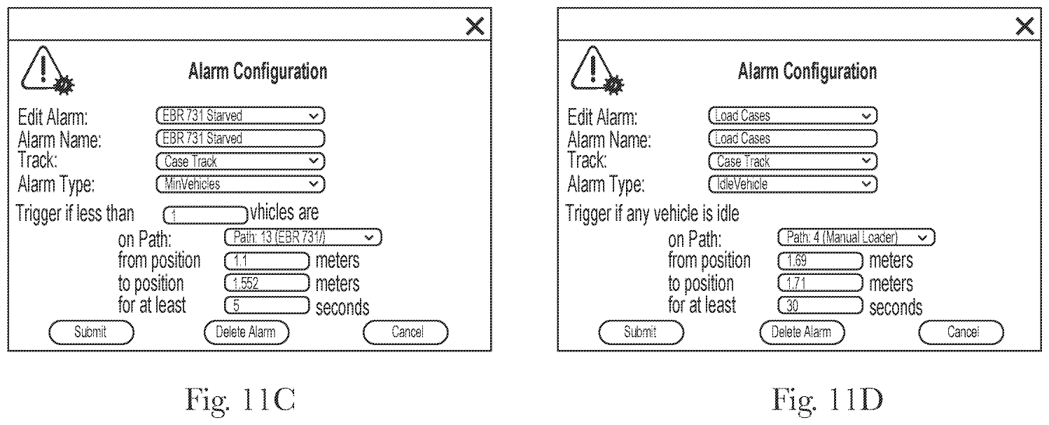

The controller is enabled to have one or more displays wherein one or more operators may interact with the controller. Display may be a representative graphical style as shown in FIG. 10. The display may be in the form of a list of alarms. The alarms may be configured to have set trigger conditions and reactions. FIGS. 11A-D show four representative alarm configurations. As shown in FIG. 11A-D, the system may allow one to configure alarms such that they are triggered based on set conditions. Additionally, one may set the desired reaction to an alarm.

The controller may record history either internally or to a third system such as a cloud based storage system. The controller may be able to summarize recorded history. The controller may be able to analyze recorder history to identify such items as repeated alarm events, alarms leading to the most production losses over a specified time frame, determining which alarms were active during production losses, determine which vehicles caused alarm to determine problematic vehicles.

The multi-dimensional warning system may utilize an alarm that may require an operator action. An example of an operator action may include loading or offloading of product, removing physical obstructions from vehicles that are physically obstructed, assessing unit operation stations that are starved or blocked, and/or assessing unit operations that are too slow. Other alarms that may require an operator action may include situations wherein a vehicle is stuck at a unit operation station. This may be due to an issue with the unit operation station.

The multi-dimensional warning system may also be used to unjam operations wherein a vehicle is reversed to clear a unit operation station, reject product if vehicle movement operates that a unit operation may not have ran smoothly. For example, shrink sleeving, improper fill level, cap placement incorrectly.

The multi-dimensional warning system may notify individual operators. The multi-dimensional warning system may utilize different alarms to call different operators to fix different issues. The alarms may be configured by alarms such that some are audible, some visible, some audible with siren, some. And any combination thereof, notifying human, and fixing it oneself.

### Examples

A. A system comprising:

a plurality of containers for holding a fluent material;

a plurality of vehicles for containers, wherein a container is disposed on a respective vehicle to form a container-loaded vehicle, there being a plurality of container-loaded vehicles;

a track system comprising a track on which container-loaded vehicles are propellable, said track comprising:

at least one unit operation station disposed along the track and configured to perform a container treatment operation on at least one container-loaded vehicle; and

a multi-dimensional warning system that incorporates the individual vehicles, one or more of the unit operation systems, and the track,

wherein the multi-dimensional warning system is enabled to raise one or more alarms.

B. The system of paragraph A, wherein the multi-dimensional warning system may modify the path of one or more vehicles based upon an alarm.
C. The system of any of the preceding paragraphs, wherein the multi-dimensional warning system stores a record of data points and analyses the data points for system inefficiencies.
D. The system of paragraph C, wherein the multi-dimensional warning system comprises an alarm based upon the comparison between target data and stored data.
E. The system of any of the preceding paragraphs, wherein the multi-dimensional warning system comprises at least one alarm for at least one vehicle.
F. The system of paragraph E, wherein the at least one alarm for at least one vehicle is activated by criteria selected from one or more of detected velocity, commanded velocity, position, presence, status of being under the influence of a command to move from its present position, contact sensor on the vehicle, distance sensor on the vehicle, a distance detection between the vehicle and another vehicle or another item on the track, or a combination thereof.
G. The system of paragraph F, wherein the at least one alarm is configured to be activated by criteria selected from the group wherein the criteria is limited to a specified region of the track.
H. The system of any of the preceding paragraphs, wherein the multi-dimensional warning system comprises at least one alarm for a grouping of vehicles.
I. The system of paragraph H, wherein the at least one alarm for at least one grouping of vehicles is selected from the group comprising an alarm is raised if there are, for example, a number of vehicles in a particular region of the track exceeding more than a maximum number or less than a minimum number, the absence of any vehicles in a particular region of the track from the grouping, a maximum velocity, a minimum velocity, an average velocity, or combinations thereof.
J. The system of any of the preceding paragraphs, wherein the multi-dimensional warning system comprises at least one alarm for at least one unit operation station.
K. The system of paragraph J, wherein the at least one alarm is selected from the group comprising availability of the unit, pressures during filling versus target pressures, detected temperature versus target temperature, and nozzle conditions, and combinations thereof.
L. The system of paragraph J, wherein the at least one alarm is selected from the group comprising proper spacing between containers for the given containers, proper pressure grip of the packing units dependent on the desired pressure, presence of the container vehicles, and combinations thereof.
M. The system of paragraph J, wherein the at least one alarm is selected from the group comprising detection and/or presence of a cap, torque applied during capping for a given set point, grip strength applied, detection of a collision between a vehicle and the unit operation, and combinations thereof.
N. The system of any of the preceding paragraphs, wherein the multi-dimensional warning system comprises at least one alarm, wherein the at least one alarm for the track is selected from the group comprising vehicle speeds at turns, vehicle speeds at switches, vehicle speeds at any other particular type of track, and combinations thereof.

The dimensions and/or values disclosed herein are not to be understood as being strictly limited to the exact numerical dimensions and/or values recited. Instead, unless otherwise specified, each such dimension and/or value is intended to mean the recited dimension and/or value and a functionally equivalent range surrounding that dimension and/or value. For example, a dimension disclosed as “40 mm” is intended to mean “about 40 mm”.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it could be obvious to those skilled in the art that various other changes and modifications can be made without departing from the spirit and scope of the invention. It is therefore intended to cover in the appended claims all such changes and modifications that are within the scope of this invention.

What is claimed is:

1. A system comprising:
a plurality of containers for holding a fluent material;
a plurality of vehicles for containers, wherein a container is disposed on a respective vehicle to form a container-loaded vehicle, there being a plurality of container-loaded vehicles;
a track system comprising a track on which container-loaded vehicles are propellable, said track comprising:
at least one unit operation station disposed along the track and configured to perform a container treatment operation on at least one container-loaded vehicle; and
a multi-dimensional warning system that incorporates the individual vehicles, one or more of the unit operation systems, and the track,
wherein the multi-dimensional warning system is enabled to raise one or more alarms.

2. The system of claim 1, wherein the multi-dimensional warning system may modify the path of one or more vehicles based upon an alarm.

3. The system of claim 1, wherein the multi-dimensional warning system stores a record of data points and analyses the data points for system inefficiencies.

4. The system of claim 3, wherein the multi-dimensional warning system comprises an alarm based upon the comparison between target data and stored data.

5. The system of claim 1, wherein the multi-dimensional warning system comprises at least one alarm for at least one vehicle.

6. The system of claim 5, wherein the at least one alarm for at least one vehicle is activated by criteria selected from one or more of detected velocity, commanded velocity, position, presence, status of being under the influence of a command to move from its present position, contact sensor on the vehicle, distance sensor on the vehicle, a distance detection between the vehicle and another vehicle or another item on the track, or a combination thereof.

7. The system of claim 6, wherein the at least one alarm is configured to be activated by criteria selected from the group wherein the criteria is limited to a specified region of the track.

8. The system of claim 1, wherein the multi-dimensional warning system comprises at least one alarm for a grouping of vehicles.

9. The system of claim 8, wherein the at least one alarm for at least one grouping of vehicles is selected from the group comprising an alarm is raised if there are, for example, a number of vehicles in a particular region of the track exceeding more than a maximum number or less than a minimum number, the absence of any vehicles in a particular region of the track from the grouping, a maximum velocity, a minimum velocity, an average velocity, or combinations thereof.

10. The system of claim 1, wherein the multi-dimensional warning system comprises at least one alarm for at least one unit operation station.

11. The system of claim 10, wherein the at least one alarm is selected from the group comprising availability of the unit, pressures during filling versus target pressures, detected temperature versus target temperature, and nozzle conditions, and combinations thereof.

12. The system of claim 10, wherein the at least one alarm is selected from the group comprising proper spacing between containers for the given containers, proper pressure grip of the packing units dependent on the desired pressure, presence of the container vehicles, and combinations thereof.

13. The system of claim 10, wherein the at least one alarm is selected from the group comprising detection and/or presence of a cap, torque applied during capping for a given set point, grip strength applied, detection of a collision between a vehicle and the unit operation, and combinations thereof.

14. The system of claim 1, wherein the multi-dimensional warning system comprises at least one alarm, wherein the at least one alarm for the track is selected from the group comprising vehicle speeds at turns, vehicle speeds at switches, vehicle speeds at any other particular type of track, and combinations thereof.

15. A system comprising:
a plurality of containers for holding a fluent material;
a plurality of vehicles for containers, wherein a container is disposed on a respective vehicle to form a container-loaded vehicle, there being a plurality of container-loaded vehicles;
a track system comprising a track on which container-loaded vehicles are propellable, said track comprising:
at least one unit operation station disposed along the track and configured to perform a container treatment operation on at least one container-loaded vehicle; and
a multi-dimensional warning system that incorporates the individual vehicles, one or more of the unit operation systems, and the track,
wherein the multi-dimensional warning system is enabled to raise one or more alarms and
wherein the multi-dimensional warning system stores a record of data points and analyses the data points for system inefficiencies.

16. The system of claim 15, wherein the multi-dimensional warning system may modify the path of one or more vehicles based upon an alarm.

17. The system of claim 15, wherein the multi-dimensional warning system comprises an alarm based upon the comparison between target data and stored data.

18. The system of claim 15, wherein the multi-dimensional warning system comprises at least one alarm for at least one vehicle.

19. The system of claim 18, wherein the at least one alarm for at least one vehicle is activated by criteria selected from one or more of detected velocity, commanded velocity, position, presence, status of being under the influence of a command to move from its present position, contact sensor on the vehicle, distance sensor on the vehicle, a distance detection between the vehicle and another vehicle or another item on the track, or a combination thereof.

20. The system of claim 15, wherein the multi-dimensional warning system comprises at least one alarm for a grouping of vehicles.
